(19) United States
(12) Patent Application Publication
(10) Pub. No.: US 2011/0284689 A1
(43) Pub. Date: Nov. 24, 2011

(54) AIRCRAFT CABIN PANEL FOR SOUND REDUCTION

(75) Inventors: Christian Thomas, Hamburg (DE); Florian Hesselbach, Blaustein (DE); Stephan Hoetzeldt, Bremen (DE); Wilfried Michaelis, Ritterhude (DE); Uwe Schneider, Jork (DE); Ralph Sturm, Schenefeld (DE); Arno Berger, Hamburg (DE)

(73) Assignee: Airbus Operations GmbH, Hamburg (DE)

(21) Appl. No.: 13/140,068

(22) PCT Filed: Dec. 17, 2009
(86) PCT No.: PCT/EP2009/067457

§ 371 Date: Aug. 2, 2011

Related U.S. Application Data
(60) Provisional application No. 61/201,930, filed on Dec. 17, 2008.

(30) Foreign Application Priority Data
Dec. 17, 2008 (DE) 10 2008 062 703.8

(51) Int. Cl. B64C 1/40; G10K 11/16

(52) U.S. Cl. 244/1 N

(57) ABSTRACT

The present invention relates to an aircraft cabin panel for sound reduction in an interior space. The invention in particular also relates to an aircraft comprising an interior lining with sound-absorbing and sound-reducing panels. In order to provide a panel that is optimized in terms of the design space required by it and in terms of its weight, for use in aircraft, which panel provides improved sound reduction and sound absorption characteristics, an aircraft cabin panel for sound reduction in an interior space is provided, which aircraft cabin panel in at least one region comprises a sandwich construction with a core layer, a first covering layer and a second covering layer. The core layer comprises sound absorbing open-pore core material. The first and the second covering layer are connected to the core layer in a planar fashion. The first covering layer is arranged towards the sound waves to be absorbed and the second covering layer is arranged opposite the first covering layer. The first covering layer is designed so as to be acoustically transparent.

The present invention relates to an aircraft cabin panel for sound reduction in an interior space. The invention in particular also relates to an aircraft comprising an interior lining with sound-absorbing and sound-reducing panels.

Sound-reducing panels are used in aircraft in the region of the cabins in order to improve the acoustic characteristics of the cabin interior in that the sound, which is perceived to be annoying, is reduced by the panels. Increased demand for comfort relating to spaces in general is also associated with increased demand for passenger comfort in aircraft, among other things also high demands concerning cabin acoustics in flight. For this purpose it is desirable in the interior, for example of aircraft passenger cabins, to use panels for sound absorption in order to minimize noise exposure in the cabin interior. The sound to be reduced is, for example, sound generated by the engines, sound caused by the mechanical air conditioning or ventilation plant, and not least also sound generated by the aircraft passengers themselves. Apart from the reduction of the sound generated, generally-speaking an increase in the area of acoustic absorption provides one option of reducing the sound level within the interior of an aircraft, for example within the aircraft cabins. Furthermore, a reduction in the sound reflections and in the reduction of the sound entry in direct proximity to passengers contributes to improved sound quality. For the first-mentioned reduction in the sound transmission of the engine and of boundary layer noise into the cabin, for example in passenger aircraft the acoustic effectiveness of the insulation material is increased, decoupling of structure-borne noise of the cabin lining elements is improved, or insulation of the lining elements against airborne noise is optimized. These measures are associated with a disadvantage in that not only are they often associated with an undesirable increase in weight, but they are also unable to reduce the sound generated in the cabin itself. To improve the acoustic characteristics of aircraft cabins it is, for example, known to use the region of the cabin lining for a wide-band sound-absorbing effect. For example, from DE 10 2005 016 653 A1 a sound-absorbing panel is known in which a sandwich panel is designed so as to be acoustically transparent, and on the panel side facing away from the cabin a porous absorber that is effective over a wide spectrum is arranged. The acoustic transparency of the sandwich panel, which represents the actual cabin lining, is achieved in that a honeycomb-shaped core structure comprises acoustically transparent covering areas. However, the absorber is associated with an increase in the design space and with additional weight. Due to the transparency of the panel, its weight cannot be used in terms of acoustic insulation. DE 3720371 C2 describes a lightweight composite panel in which a honeycomb core is arranged between two covering layers. The honeycomb core is filled with a porous absorber material, and the covering layer facing the interior space is designed so as to be acoustically transparent. However, it has been shown that incorporating the absorber material also results in additional weight and requires additional steps during the manufacturing process. However, an increase in weight is also accompanied by economical and ecological disadvantages in the operation of the airplane or of some other aircraft. In connection with the ever-increasing cost of fuel and the generally-recognized significance of CO₂-emission, the aspect of component weight assumes a central position during component development in the field of aviation.

There is thus a need to provide a panel that is optimized in terms of the design space required by it and in terms of its weight, for use in aircraft, which panel provides improved sound reduction and sound absorption characteristics.

According to the invention, to meet this objective, an aircraft cabin panel for sound reduction in an interior and an aircraft comprising a cabin, arranged within the fuselage, with an interior lining according to one of the independent claims are provided.

In a preferred embodiment, an aircraft cabin panel for sound reduction in an interior is provided, which aircraft cabin panel in at least one region comprises a sandwich construction with a core layer, a first covering layer and a second covering layer. The core layer comprises a sound-absorbing open-pore core material. The first and the second covering layers are connected in a planar fashion to the core layer. The first covering layer is arranged in the direction of the sound waves to be absorbed, and the second covering layer is arranged opposite the first covering layer.

In a preferred embodiment a first region comprises the sandwich construction for sound absorption in the interior space of the aircraft, wherein the first covering layer comprises a first space-enclosing surface.

The panel according to the invention is associated with an advantage in that the open-pore core material on the one hand acts as a porous absorber, and on the other hand, due to the planar connection of the core material to the covering layers, provides a sandwich structure with very good specific mechanical and static characteristics. The acoustic transparency of the first covering layer, which faces the sound field to be attenuated or absorbed, ensures an entry of the sound into the core material through the covering layer, which core material absorbs the sound. In other words, a cabin panel is provided that comprises improved sound (acoustic) absorption characteristics and at the same time is easy to produce. This is achieved, for example, in that the open-pore core material is preferably provided as a panel-shaped semi-finished product so that handling it is considerably simplified.

Since the first covering layer and the second covering layer, due to the connection in planar fashion with the core layer, provide a bonding effect, in this region the core layer apart from its acoustic tasks, can also assume static functions together with the covering layers. Consequently the panel can be designed so as to be more lightweight and thinner.

The open-pore core material provides an advantage in that on the one hand it is effective as a porous absorber, while on the other hand due to the connection in planar fashion of the core material to the first covering layer it provides a multilayer structure with good specific mechanical and static characteristics.

According to an exemplary embodiment of the invention, the core layer comprises a pressure-resistant material.

According to an exemplary embodiment of the invention, the core layer comprises an open-pore or open-cell foam material.

According to an exemplary embodiment of the invention, the open-pore foam material is a hard foam.

The use of a foam as a core material provides an advantage in that, already during manufacture of the semi-finished product, the thickness of the core layer, to be used at a later stage, of the semi-finished product can be taken into account so that the core material, i.e. the foam, in the form of a panel can be directly connected to the first and to the second covering layers.

Preferably, the weight per unit volume of the core material equals the weight per unit volume of the commonly-used core materials for panels.

In this manner aircraft cabin panels for the cabin lining, so-called lining elements, can be provided which, with similar panel thicknesses, in terms of weight are similar to lining components that are currently in widespread use. If a core material with a lighter weight of unit volume is used, lighter panels with the same thickness can be achieved, or with the same weight and thicker panels, improved acoustic absorption characteristics can be achieved.

Furthermore, as a result of the core material, good thermal insulation characteristics of the panel can be achieved so that thermal insulation of the exterior wall can be reduced somewhat, which results in gaining additional space and achieving further weight reduction. In this manner the core layer can assume static, acoustic and thermal tasks with one material.

According to an exemplary embodiment of the invention, the foam material is of low density. For example, the foam material comprises a density of max. 300 kg/m³, e.g. a density of max. 150 kg/m³.

According to an exemplary embodiment, the foam material comprises a density of 30 kg/m³ to 110 kg/m³.

According to an exemplary embodiment of the invention, the foam material comprises a pressure resistance of approx. 200 kPa to approx. 1500 kPa at a density of between approx. 30 kg/m³ and approx. 120 kg/m³.

According to an exemplary embodiment of the invention, the foam material comprises a flexural rigidity of 200 kPa to approx. 2200 kPa at a density of between approx. 30 kg/m³ and approx. 120 kg/m³.

According to an exemplary embodiment of the invention, the foam material comprises a transversal resistance or shear resistance of 400 kPa to approx. 1500 kPa at a density of between approx. 30 kg/m³ and approx. 120 kg/m³.

According to an exemplary embodiment of the invention, the foam material comprises a tensile strength of 500 kPa to approx. 3000 kPa at a density of between approx. 30 kg/m³ and approx. 120 kg/m³.

For example, the core layer comprises a high-performance thermoplastic, e.g. an amorphous polyetherimide plastic.

In a preferred embodiment, the first region forms an absorption region on the cabin side. For example, the panel is a cabin lining panel.

In a preferred embodiment, the panel features the described structure over the majority of its area, which structure, depending on the location of use within the cabin, can be distributed across the panel. In this manner panels can be provided that apart from the acoustic function can, for example, also carry out other tasks or assume other functions. For example, panels used in the lower region of aisle regions can be adapted to cope with the heavier mechanical loads, e.g. as a result of impact from items of baggage etc., which heavier mechanical loads are likely to occur in these regions. A further example relates to panels that comprise an opening for a cabin window.

In a preferred embodiment, edge regions are provided, and the core layer, which is connected in a planar fashion to the first and the second covering layers, which core layer comprises the sound-absorbing open-pore core material, extends between the edge regions.

In this manner panels can be provided which, for example, already during their manufacture can more easily be adapted to complicated edge geometries. For example, ceiling panels can comprise a relatively flat region, and lateral regions that are curbed more pronouncedly. By arranging the acoustically effective structure in the flat region, manufacture of this sandwich construction is simplified, for example if panel-shaped semi-finished products can be used for the core layer. The edges can then comprise a structure that is better suited to the manufacture of curved connections; e.g. known edge geometries can be used. Consequently, the panels can be affixed without any problems with the use of known connecting constructions.

In this manner it is also possible to provide panels whose edges do not differ from those of conventional cabin panels so that they are suitable for being combined with known panels, in particular also in the context of retrofitting measures.

In a further preferred embodiment, the core layer, which is connected in a planar fashion to the first and second covering layers, extends from the sound-absorbing open-pore core material across the entire panel.

The acoustically-effective structure over the entire panel area ensures maximum acoustic effect. At the same time the manufacturing process is simplified and thus the manufacturing costs are reduced.

There is a further advantage in that as a result of the above the panels can be made available as a kind of semi-finished product that, for example, can be better adapted to the precise dimensions of a particular installation situation.

In the context of the present invention the term “acoustic transparency” relates to the characteristic of letting the sound, which impinges the surface, to pass through as far as possible without any hindrance. The term “acoustic transparency” relates in particular to the frequency range of intelligibility of human speech. Usually, a range of 500 to 4000 Hz is stated for this. “Acoustic transparency” thus means that sound waves are to be let through as far as possible in the entire frequency range mentioned. Only then is wide-band influencing of the acoustics in the cabin space possible in the sense of improving intelligibility, a notion which is also referred to as the “speech interference level”.

Expressed in a somewhat simplified manner, the acoustic transparency is determined by the interaction between the materials used and their attachment or construction. At first a differentiation between air-permeable and air-impermeable materials is useful. The acoustic transparency of air-permeable materials is characterized by their flow resistance. Air-impermeable materials are acoustically transparent only under certain boundary conditions. For example, a thin, lightweight, panel-shaped air-impermeable material that is loosely suspended can reproduce a frequency range (nearly) without hindrance in that the panel does (almost) not provide any resistance to the air waves, and the sound waves can pass through the layer (nearly) without hindrance. In contrast to this, the same material, when firmly clamped, in particular when clamped at small spacing, offers significantly larger resistance to the impinging sound waves. Thus, the actually achieved effect, rather than some isolated consideration of a material per se or merely the consideration of a particular construction, is the decisive factor in assessing acoustic transparency.

In a preferred embodiment, according to the invention the covering layer that faces the sound is acoustically transparent also to sound waves that impinge the panel obliquely, e.g. at a flat angle. In an advantageous manner this results in still better absorption by the panel, because obliquely impinging sound can spread over a longer distance in the core material that has an absorbent effect. This results in particularly good suitability for use in passenger cabin regions, in which, as a rule, a multitude of sources emit sound in entirely different directions.

In a preferred embodiment, the flow resistance of the first covering layer does not exceed 1000 Ns/m³.

With such a flow resistance it is ensured that the covering layer facing the space does not have a negative effect on the absorption capacity of the panel. In this arrangement the flow resistance relates to the entire covering layer, i.e. for example to a lattice prepreg with the decorative element arranged in front of it.

The flow value is an average value of the area under consideration, in which value in principle some regions can also be more tightly closed while others can be more permeable. In this manner, for example, heterogeneous surfaces can be designed which are, for example, textured in the visible area. Since, as has already been mentioned, the sound can also impinge the panel obliquely and can enter the absorber in this direction, the core material can, for example, be activated as an absorber even where the acoustic permeability is locally somewhat reduced; for example, in the case of denser regions arranged in a strip-shaped manner the absorber can become effective in an absorbent manner over the entire area.

In a particularly preferred embodiment, the flow resistance of the first covering layer does not exceed 500 Ns/m³.

At this value the covering layer can be considered to be acoustically very transparent.

In a still further preferred embodiment, the flow resistance of the first covering layer is at most 200 Ns/m³.

Below this value a layer is almost entirely acoustically transparent. Further reductions result in barely perceptible improvements.

In the context of the acoustic transparency of the covering layer, irrespective of the value achieved, it should in particular be noted that no reflection of the high frequencies occurs, e.g. at the surface of the covering layer, because these frequencies thus continue to be present as an acoustic load in the interior space, and cannot be absorbed by the absorber material.

In a preferred embodiment the first covering layer has multiple layers.

This ensures that the individual functions to be fulfilled by the covering layer can be covered by different materials in different layers.

In a particularly preferred embodiment, the first covering layer comprises a first lattice prepreg and a cover that forms the first surface, wherein the first lattice prepreg is connected in a planar fashion to the core layer.

In this arrangement the lattice prepreg assumes static or mechanical tasks in that, due to the bonding effect, it stabilizes the core situated behind it, thus giving the panel the stability and rigidity, in particular flexural rigidity, that is necessary for a cabin lining. The lattice prepreg is, for example, a lattice structure constructed from high-performance fibers and a matrix material, which lattice structure as a rule is connected to the core in a pressing process at temperature. The cover facing the interior space then assumes the task of providing a high-quality visual face to the panel with the core layer and the lattice prepreg.

In a preferred embodiment, the first cover comprises leather as surface material.

With correspondingly thin leather and a matching perforation pattern, in this way it is possible, for example, to achieve flow resistance values of approximately 50 Ns/m³. Leather is particularly well suited for application in high-quality cabin regions, for example in first class. Due to its relatively hard-wearing surface, leather is also suitable for regions subjected to high wear, for example in the entrance region or the aisle region.

In a preferred alternative embodiment, the first cover comprises a woven fabric as a surface material.

With a corresponding design, on the one hand with a woven fabric an acoustically transparent layer can be provided. On the other hand, a woven fabric provides a visually pleasing surface. In this arrangement it is possible, for example, to use woven fabrics that comprise the corporate color of an aircraft operator or that in some other manner reflect the corporate layout or the corporate identity. In particular, the woven fabric can also comprise logos or other graphic design elements.

Depending on the use of the panel within the aircraft cabin, the woven material can comprise a coating that has a self-cleaning effect; for example such a coating can comprise titanium dioxide. In this manner, soiling of the surface, for example in aisle regions, can be prevented.

In a preferred embodiment, a nonwoven formed fabric, i.e. fleece material, is provided between the surface material and the first lattice prepreg.

In this manner the surface material, which, simply stated, is primarily a decorative element, can be lined. In this manner it is, for example, possible to compensate for instances of unevenness in the region of the underlying construction so that greater surface accuracy is provided. On the other hand, in this way it is also possible to achieve different haptic characteristics of the cabin panel, which for example in the case of cabin walls can create a higher-quality impression with the user, for example in the case of cabin walls that are arranged laterally beside the seats, which cabin walls, as a rule, are subjected to contact by users, for example if a user leans laterally against the wall. In this region a softer surface may in certain circumstances be tantamount to enhanced user comfort and may thus improve the quality of travel.

In a further preferred embodiment the second covering layer is designed so as to be acoustically transparent.

When a cabin panel is arranged in the region of the fuselage insulation, i.e. in direct proximity to the exterior wall that comprises corresponding insulation that is provided both as thermal insulation and as acoustic insulation, the absorbent panel, as a result of the acoustic transparency of its rear, together with the fuselage insulation which relative to the acoustic input from the room is situated behind the panel, can also act as an absorber for low frequencies.

A further preferred alternative embodiment provides for the cover on the one hand to comprise a certain acoustic transparency, while on the other hand, based on the structure of the woven fabric, already some influence on the acoustic mode of action of the cabin panel is ensured.

In this manner, for example, the sound absorption characteristics or some other acoustic characteristics of the panel can be further improved, e.g. the sound can already be attenuated by the cover.

In a preferred embodiment, the second covering layer has multiple layers and comprises a second lattice prepreg, wherein the second lattice prepreg is connected in a planar fashion to the core layer.

The second lattice prepreg ensures the highest possible flexural rigidity of the panel while at the same time providing maximum acoustic transmissivity through the second covering layer.

In a further preferred embodiment, the second covering layer is designed so as to be water-impermeable.

In this manner any infiltration of condensed water into the panels is prevented, wherein it is often not possible to prevent such condensed water from arising in the region between the exterior skin of the aircraft and the cabin wall.

In a further preferred embodiment, the second covering layer comprises a thin water-impermeable foil that comprises a weight per unit area of at most 100 grams per square meter.

The water-impermeable foil prevents rear ingress of the already mentioned condensed water, which can form in the region of the fuselage insulation. Due to the light weight per unit area the acoustic transparency relative to those frequencies that are still to be absorbed by the fuselage insulation situated behind the aforesaid is nevertheless ensured.

In an alternative embodiment, the second covering layer is designed so as to be acoustically insulating, i.e. the second covering layer has an acoustically insulating effect.

In this manner, for example, a situation is prevented in which the sound, which, for example, is not completely absorbed by the absorber, can pass through the panel.

Moreover, this prevents the occurrence of sound arising outside the cabin region from passing through the cabin wall into the cabin. This embodiment variant is suitable in particular in those cases where increased acoustic input from the outside into the cabin is to be expected, for example as a result of engine noise. The sound to be attenuated can, however, also relate to the sound arising during operation of the aircraft as a result of the flow boundary layer on the exterior skin. Since the component is thus acoustically transparent only on one side, apart from absorption characteristics it also provides a degree of acoustic insulation. In this arrangement the degree of acoustic insulation is determined by the design of the second covering layer. Since the second covering layer is located on the side facing away from the cabin, constructions and materials can be used which on the one hand ensure a good bonding effect with the core material, while on the other hand being designed for optimization of the degree of acoustic insulation, wherein in these constructions the visual effect does not have to be taken into account. In contrast to known honeycomb cores, the porous core material itself also provides a degree of acoustic insulation. In other words, a higher degree of acoustic insulation of the component can be achieved in a simple manner. The panel according to the invention thus overall results in a significant reduction in noise in the interior of the aircraft.

For example, to this effect, in a preferred embodiment the second covering layer can have multiple layers and can comprise a second lattice prepreg.

The second lattice prepreg contributes to a further improvement of the static and mechanical characteristics of the panel in that it additionally stabilizes the core structure. It is then possible to apply an acoustically effective insulation material to the second lattice prepreg. In a design as an acoustically-closed rear covering layer this acoustic function is ensured by further layers which when viewed from the interior of the space are arranged behind the second lattice prepreg.

In a further alternative embodiment, the second covering layer comprises a second space-enclosing surface.

In this manner a cabin panel is provided which is suitable as a panel within the cabin, for example as a cabin partition wall, because it can be associated on both sides with a cabin interior region.

In a preferred embodiment, the second covering layer has multiple layers and comprises a second lattice prepreg and a second cover that forms the second surface.

In this arrangement the second lattice prepreg assumes mechanical or static tasks in that together with the core layer and the first lattice prepreg, which is arranged on the other side, it forms a flexurally rigid composite panel. The second cover assumes the task of providing a panel that on the second side, too, comprises a visually pleasing surface.

Preferably the two covers, i.e. the first cover on the first side of the covering layer and the second cover on the opposite, second, side of the covering layer are different in order to provide the different spatial regions with a different design. For example, the first cover can be associated with a region of first class, while the second cover can be associated with a region of second class, and for this reason the two covers can also be visually different. Of course, in this arrangement the two covers are designed so as to be acoustically transparent.

In a further preferred embodiment, the second cover comprises a woven fabric as a surface material.

In a further preferred embodiment the second cover has multiple layers.

Also preferred is an embodiment in which the first cover has multiple layers.

The multilayer design of the cover makes it possible, for example, to line the visible woven fabric with a nonwoven formed fabric.

In a preferred embodiment a nonwoven formed fabric is provided between the cover and the lattice prepreg.

In this manner it is possible, for example, to bridge instances of unevenness in the region of the underlying core structure and of the lattice prepreg connected to the core structure. Furthermore, the incorporation of additional layers also makes it possible to provide additional visual effects, for example the arrangement of two fabrics, one placed on top of the other, which can result in a moiré pattern.

In a preferred embodiment, a nonwoven formed fabric is provided between the surface material and the lattice prepreg.

In a preferred embodiment, in order to reduce the sound input into the interior, a second region is provided that comprises the sandwich construction, wherein the second covering layer in the second region comprises a space-enclosing surface, and the first covering layer forms a rear area of a cabin lining.

In a preferred embodiment, the second region is arranged in an edge region of the panel.

In this manner the sound that impinges the cabin panel from the rear or from the outside, respectively, can be attenuated in a targeted manner at the connecting regions of the panel, in which regions increased sound input into the cabin can occur, for example as a result of open joints.

In a preferred embodiment, the panel is a dado panel.

This term refers, for example, to those panels of a cabin lining, which panels are arranged laterally on the exterior wall and in which panels as a rule at the lower end in the region of the floor connection an air suction-removal opening/air discharge opening is provided.

In a preferred embodiment, the edge region comprises a multiple-shell construction and forms a hollow space for guiding air of an air conditioning or ventilation plant of an aircraft, wherein the first covering layer of the second region is arranged so as to face the second region.

The term “hollow space” refers, for example, to a duct-like cross section that is open on at least two ends, which cross section is formed by the edge region comprising a multiple-shell construction, for guiding or ducting or for the flow-through of the air to be removed or supplied. The hollow space forms a through-opening in the edge region and represents, for example, a type of duct or duct segment or pipe or pipe segment. The cross-section of the hollow space is, for example, a free cross-sectional region, formed by two walls, through which cross-sectional region the air can flow. The hollow space represents a cavity or recess that is open on at least two sides, i.e. said hollow space comprises at least one first opening through which the air can enter the hollow space, and at least one second opening from which the air can leave the hollow space. The hollow space or hollow body is designed in such a manner that it forms a free flow cross-section and can guide the air along the distance of the hollow space. The hollow space thus forms a guide for the air, or an air guide or an air duct. In relation to the region of the cabin and the region behind the cabin panel, the hollow space represents a passage or connecting duct to guide air.

In this manner an air exchange with the cabin space can be made possible in which the sound input is reduced because the sound on the path that is open to the air in the direction of the cabin interior is absorbed as completely as possible by the core material.

In a preferred embodiment, the hollow space is longitudinally directed, with its longitudinal sides extending parallel to the edge region of the panel. For removing air or for supplying air the hollow space is partly open on a first longitudinal side facing the edge region.

In a preferred embodiment, for supplying air or for removing air the hollow space is at least partly open on a second longitudinal side that is opposite the first longitudinal side.

In a preferred embodiment, in the direction of through-flow the hollow space comprises at least one offset and forms an offset sound path.

For example, in cross-section the hollow space is designed as a labyrinth.

In a preferred embodiment, the hollow space forms a gap for air removal, which gap is a permanently open through-gap relative to the longitudinal direction or the edge region.

The actual air suction openings of the air conditioning system can thus be arranged behind the lining. Except for the design of the open joint, which, for example, as a shadow joint with an offset cross section blocks the view onto the region behind the panel, the appearance of the cabin lining is not affected.

In a preferred embodiment, the hollow space is delimited by a hollow-space wall which also comprises the sandwich construction, wherein in each case the first covering layer is arranged so as to face the hollow space.

In this manner effective sound absorption can be provided, which is associated with advantages during production and installation. For example, in a single-piece design of the panel the hollow space can be produced in a simple manner in that the core material is produced as a semi-finished product.

There is a further advantage in that the required design space is reduced to a minimum because the material of the panel is already absorbent. There is no need to provide absorbers that would have to be affixed in addition, which would mean more design space or a smaller clear cross-section.

In a preferred embodiment, the hollow space is designed as a sound absorber.

In a preferred embodiment, the first covering layer of the second region is arranged on the opposite side of the first covering layer of the first region.

In this manner on both sides sound that impinges on the panel can be reduced. For example, in this manner the sound in the interior, which sound among other things is also generated by the passengers themselves, can be attenuated by absorption, as can sound that impinges on the side facing away from the cabin, e.g. noise from the turbines that enters from the outside.

In a preferred embodiment, the first and the second regions are arrange so as to be offset from each other.

Consequently the sound in the region of head height in the cabin interior can be absorbed, and the noise input at the lower edges, and of course also on the upper or lateral edges, can be reduced by way of open joints.

Preferably the cabin panels according to the invention comprise the same thickness as conventional panels.

This results in an advantage in that the panel according to the invention can also be used in combination with standard cabin panels. Furthermore, the panel according to the invention is also suitable for subsequent use in already existing structures, for example in the context of periodical remodelling of aircraft cabins or so-called retrofittings. Furthermore, according to the invention, an aircraft comprising a fuselage construction and a cabin that is arranged within the fuselage are provided, which cabin, at least in some sections, is enclosed by an interior lining made from panels. In this arrangement, at least some of the panels are designed as sound-absorbing panels according to one of the preceding embodiments.

In this manner an aircraft is provided in which the acoustic interior of the cabin is improved to such an effect that the improved absorption characteristics of the interior lining result in a reduction in the noise in the aircraft interior. In this arrangement the panels according to the invention ensure that despite an improvement in the acoustic characteristics there is no increase in the component weight, which at the same time would be associated with an increase in the fuel consumption of the aircraft in operation. There is a further advantage in that in comparison to those panels, on which at the rear an additional absorber element is arranged, a smaller installation space is required. Consequently there is more space available for the actual use of the cabin, which means an additional increase in user comfort. An increase in the use area at the same time also means improved utilization of the aircraft, which in turn is economically advantageous.

It should be pointed out that the above description of the invention and the following descriptions of examples as well as the claims, while worded in terms of an aircraft, however in the context of the present invention the term “aircraft” not only relates to airplanes but in particular also to helicopters. The invention and the scope of protection of the claims thus relate to aircraft in general, for example to airplanes and helicopters, not only to airplanes.

Below, exemplary embodiments of the invention are discussed in more detail with reference to the enclosed drawings. The following are shown:

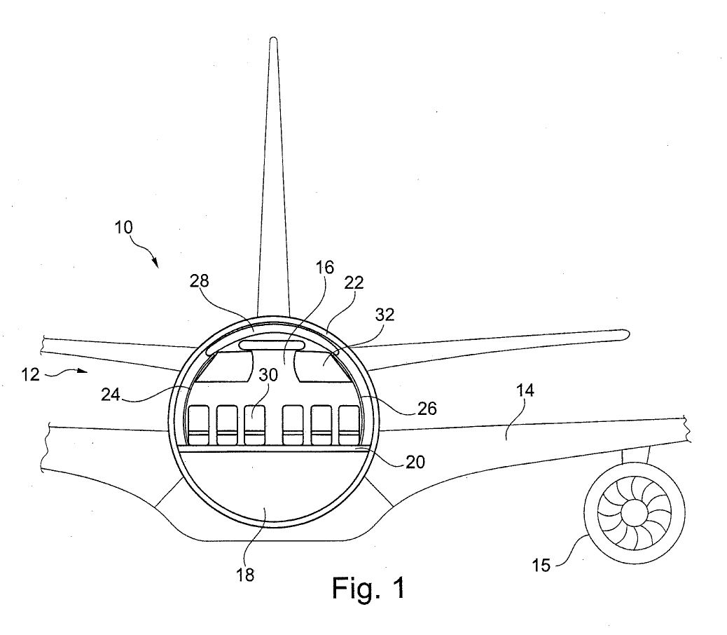

FIG. 1 a cross section of an aircraft comprising a cabin lining with panels according to the invention;

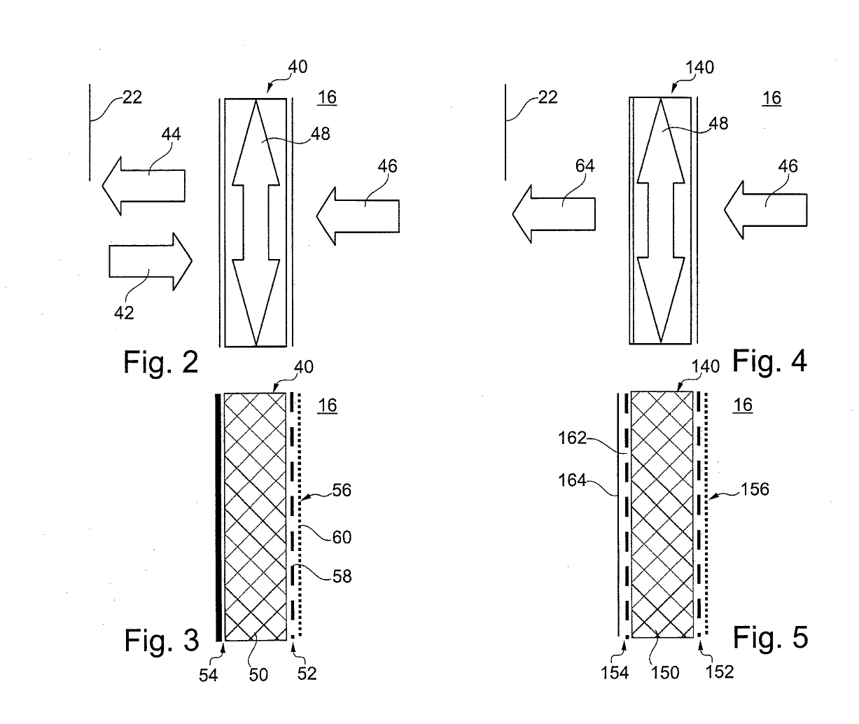

FIG. 2 a diagrammatic view of the acoustic requirements of a cabin lining panel in a first embodiment according to the invention;

FIG. 3 a diagrammatic section of a cabin panel according to the invention;

FIG. 4 a diagrammatic view of the acoustic requirements of an aircraft cabin panel according to the invention in a second embodiment;

FIG. 5 a section of the panel of FIG. 4;

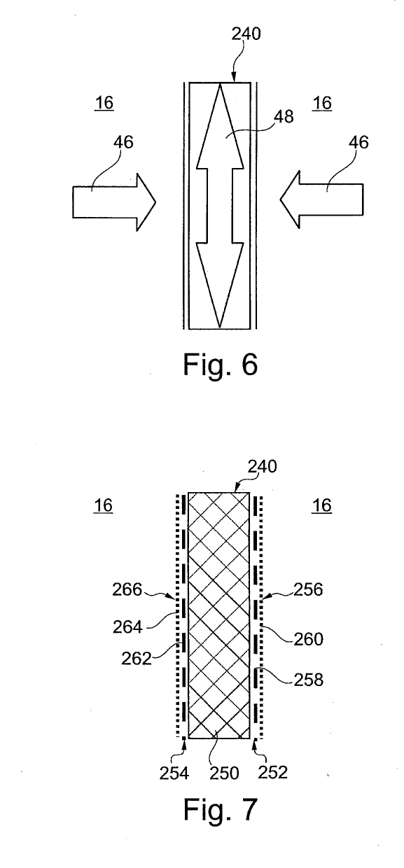

FIG. 6 a diagrammatic view of the acoustic requirements of a cabin panel in a further embodiment;

FIG. 7 a diagrammatic section of a cabin panel according to FIG. 6.

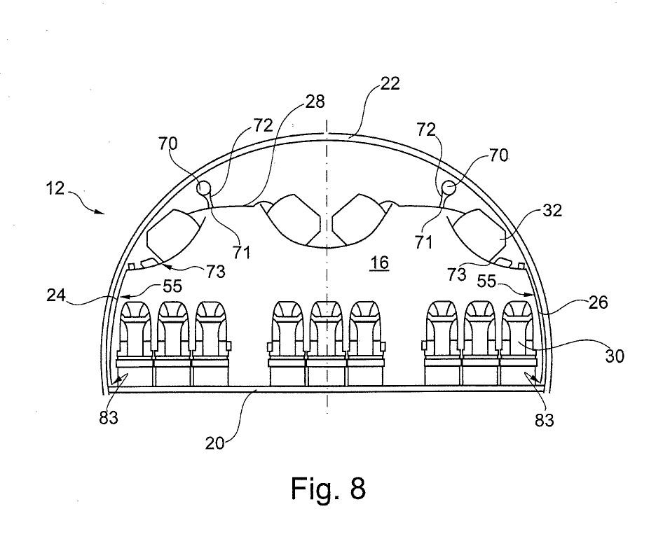

FIG. 8 a further cross section of an aircraft comprising a cabin lining with panels according to the invention;

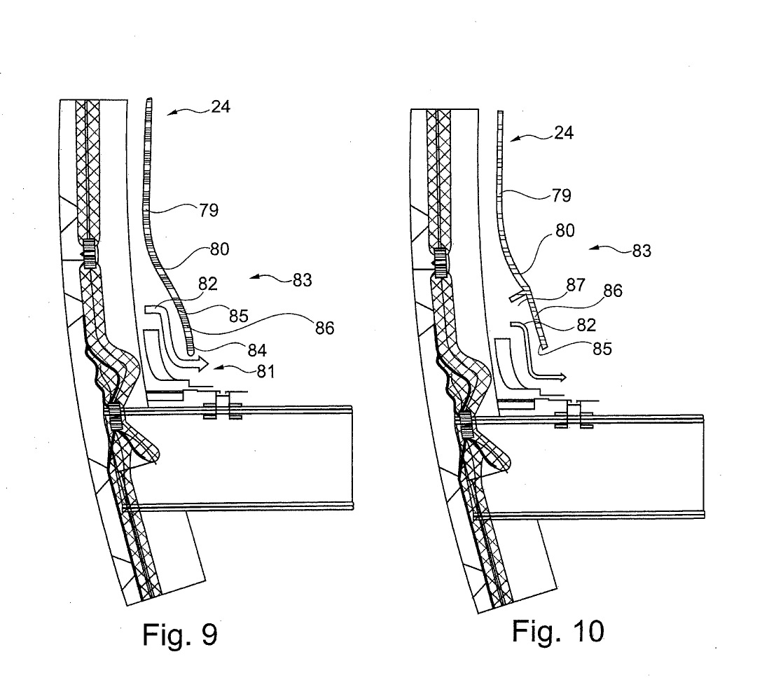

FIG. 9 a lower region of the cabin lining according to FIG. 8;

FIG. 10 a further embodiment of a lower region of the cabin lining according to FIG. 8; and

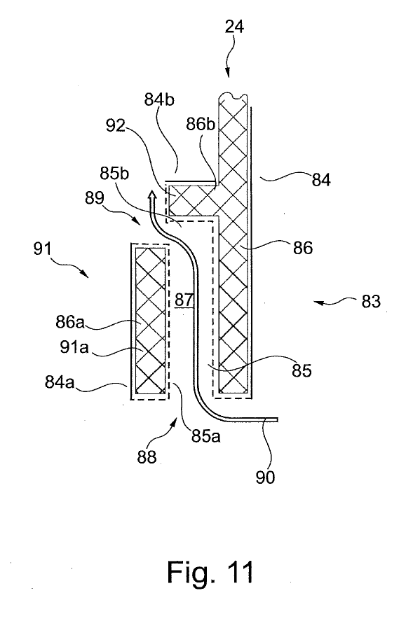

FIG. 11 a diagrammatic view of the lower region of the cabin lining according to FIG. 10.

FIG. 1 shows an aircraft 10 comprising an aircraft fuselage 12 and two laterally adjoining wings 14 on which engines 15 are provided. In FIG. 1 the aircraft fuselage 12 is shown in a section view across its longitudinal axis. The aircraft fuselage 12 is divided into an upper cabin region 16 and a cargo region 18, arranged below the aforesaid, by means of a horizontally extending floor 20. The aircraft fuselage 12 further comprises an essentially circumferential exterior skin 22 of the aircraft, which skin 22 is connected to an aircraft fuselage structure (not shown in detail). Expressed in a somewhat simplified manner, the aircraft fuselage structure comprises a type of supporting structure of frame elements and stringers, thus ensuring a stable construction for absorbing the external and internal loads.

In the cabin region 16, which is arranged above the floor 20, along the exterior wall 22 there are lateral cabin linings 24, 26 as well as an upper cabin lining 28 provided in the upper region.

The elements of the cabin lining 24, 26, 28 together with the floor 20 enclose an interior, i.e. the cabin. Within the cabin, for example, seats 30 for the passengers are arranged. Furthermore, for example, hatracks 32 are provided which are essentially located above the seat rows and which are used for holding passengers' cabin baggage. Furthermore, in the cabin region 16 also various supply lines (not shown in further detail in FIG. 1) are provided, for example relating to an oxygen supply, to an electrical supply or to an air conditioning or ventilation plant.

The external loads, for example wind loads and loads resulting from pressure differentials, acting on the fuselage region are transferred by the exterior skin 22 to the support structure of the aircraft fuselage and are thus transferred. In order to provide suitable environmental conditions within the cabin, thermal insulation is also provided in the exterior wall construction. Furthermore, the exterior wall construction is designed so as to be as sound-insulating as possible in order to limit to a minimum the noise input from the turbines 15 into the cabin 16.

Apart from the space-enclosing function of the cabin lining elements 24, 26, 28, according to the invention said cabin lining elements 24, 26, 28 are also used to influence the acoustic conditions within the cabin 16. To this effect the cabin panels 24, 26, 28 are designed to be sound-absorbing, which will be explained in further detail below with reference to FIGS. 2 and 3.

FIG. 2 diagrammatically shows the acoustic connections relating to a first exemplary embodiment of a cabin lining according to the invention. As already mentioned in the context of FIG. 1, for example in the case of passenger aircraft, usually within the fuselage construction of an aircraft, a cabin lining is arranged, which as a rule comprises several cabin panels 40, which in order to create the largest possible cabin space are usually arranged in close proximity to the exterior skin 22 of the aircraft, i.e. the panels 40 are situated between the actual cabin space 16 and the exterior skin 22. Despite the presence of insulation material in the region of the exterior skin 22, in flight there is sound entry 42 through the exterior skin into the cabin region, for example as a result of boundary layer noise and also as a result of the noise level generated by the turbines 15. At the same time, sound is generated within the cabin, for example as a result of air conditioning or ventilation plants, and not least also as a result of the people present in the cabin, which sound generation acts from the region of the cabin 16 on the panel 40. In order to create the best possible environmental conditions within the cabin, the panels according to the invention in a first embodiment, shown in FIGS. 2 and 3, are designed to reflect 44 or insulate as far as possible the sound impinging from the exterior, so that the sound impinging from the exterior does not arise in the interior as well. Furthermore, the sound level in the cabin interior can be reduced in that as much as possible of the incident sound, which in FIG. 2 is indicated by an arrow with the reference character 46, is absorbed by the cabin panel 40 according to the invention, which is indicated with a further arrow with the reference character 48.

FIG. 3 shows the aircraft cabin panel 40 in a first embodiment. In at least one region the panel 40 comprises a sandwich construction with a core layer 50, a first covering layer 52 and a second covering layer 54, wherein the latter is arranged opposite the first covering layer 52. The first covering layer 52 comprises a first space-enclosing surface 56.

According to the shown exemplary embodiment, the core layer comprises a pressure-resistant open-pore or open-cell foam material, wherein in particular a hard foam is suitable for this.

The core layer comprises, for example, a low density of max. 300 kg/m³, preferably of max. 150 kg/m³. Furthermore, the foam material comprises a pressure resistance of approx. 200 kPa to approx. 1500 kPa at a density of between approx. 30 kg/m³ and approx. 120 kg/m³ and a flexural rigidity of 200 kPa to approx. 2200 kPa at a density of between approx. 30 kg/m³ and approx. 120 kg/m³. The transversal resistance or shear resistance ranges, for example, from 400 kPa to approx. 1500 kPa at a density of between approx. 30 kg/m³ and approx. 120 kg/m³. Furthermore, the core material of the exemplary embodiment comprises a tensile strength of 500 kPa to approx. 3000 kPa at a density of between approx. 30 kg/m³ and approx. 120 kg/m³.

For example, the core layer comprises a high-performance thermoplastic, e.g. an amorphous polyetherimide plastic.

In the example shown in FIG. 3 the at least one region is designed as a first region 55 that for sound absorption in the interior comprises the sandwich construction, wherein the first covering layer 52 comprises a first space-enclosing surface 56.

The core layer 50 comprises a sound-absorbing open-pore core material. To make it possible for the core material of the core layer 50 to be acoustically effective, the first covering layer 52 is designed so as to be transparent, i.e. the sound 46 originating from the cabin region 16, which sound 46 impinges the panel 40, can pass through the first covering layer 52 as far as possible without any hindrance so that the sound subsequently impinges the core material and enters said core material, wherein as a result of the sound-absorbing open-pore structure the sound is absorbed in that location.

In order to provide a panel with adequate flexural rigidity, which panel is suitable for use as a cabin lining element, the first covering layer 52 and the second covering layer 54 together with the core layer 50 form a sandwich construction, wherein the bonding effect is achieved in that the first and the second covering layers 52, 54 are connected in a planar fashion to the core layer 50.

In order to provide acoustic transparency to the first covering layer, and in order to provide as high-quality a surface of the panel as possible, in the embodiment shown the first covering layer 52 has multiple layers. In this arrangement a first lattice prepreg 58 is provided which is connected in a planar fashion to the core layer 50. Towards the interior space, on the lattice prepreg 58a first cover 60 is provided, which forms the first surface, i.e. the space-enclosing surface 56. For example, the first cover 60 comprises a woven fabric.

Furthermore, the first cover can also have multiple layers. To this effect, for example, a nonwoven formed fabric can be provided between a woven material 60, which represents the surface material, and the first lattice prepreg 58; however, this is not shown in detail in FIG. 3. By means of the nonwoven formed fabric it is possible not only to compensate for instances of unevenness in the supporting underlying structure in the form of the sandwich in order to achieve as high-quality and visually-pleasing a panel surface as possible, but also to provide high-quality surfaces that distinguish themselves by agreeable or special haptic characteristics.

The second covering layer 54 is designed so as to be acoustically closed in order to prevent sound from entering the cabin from the outside. In this arrangement, on the one hand an acoustically-insulating effect can prevent sound from entering, and on the other hand acoustic reflection from the second covering layer 54 can take place, which in FIG. 2 is indicated by the arrow with reference character 44. In order to prevent infiltration of humidity in the form of condensed water that cannot entirely be avoided in the region of the exterior skin 22, the second covering layer 54 is furthermore designed so as to be waterproof, and consequently the absorber material cannot become humid from condensed water, which would clearly reduce its absorption characteristics.

FIG. 5 shows a further embodiment of a cabin panel 140, which embodiment corresponds to the acoustic mode of action diagrammatically shown in FIG. 4. In the field of engine development, presently considerable efforts are made to provide quieter engines. In conjunction with improved acoustic insulation characteristics of the exterior skin, for example as a result of the use of new materials, in some instances there is a small fraction of sound arising from the outside. Relative to the aforesaid, it is then the sound that impinges the cabin lining from the cabin side 16, shown with reference character 46, that plays the main role in terms of the cabin panel 140. In a manner similar to that of the cabin panel 40 of FIGS. 2 and 3, the cabin panel 140 then assumes the function of absorbing the sound impinging from the interior space, see arrow 48. In order to provide additional absorption of the cabin sound, for example resulting from low-frequency vibrations in the aircraft structure, which vibrations by way of the structural elements also affect the interior, insulation provided in the region of the exterior skin is used for further absorption, i.e. a part of the incident sound 46 penetrates the panel 140 and leaves the panel 140, which is indicated by the arrow with reference character 64. This noise fraction is subsequently absorbed by the insulation (not shown) of the exterior skin 22.

FIG. 5 shows the panel 140 that also comprises a sandwich construction with a core layer 150, a first covering layer 152 and a second covering layer 154, wherein the second covering layer is arranged opposite the first covering layer, and the first covering layer comprises a space-enclosing surface 156. The core layer 150 comprises a sound-absorbing open-pore core material, and the covering layers 152, 154 are connected in a planar fashion to the core layer.

The first covering layer 152 is designed in a manner that is analogous to the covering layer 52 of FIG. 3, i.e. in this exemplary embodiment, too, the first covering layer 152 is designed so as to be acoustically transparent in order to ensure that the sound enters the absorber material.

However, the difference consists of the design of the second covering layer 154, which in the example of FIGS. 4 and 5 is also acoustically transparent.

In order to ensure that the sound enters the core layer, the first covering layer 52 is designed in such a manner that the flow resistance of the acoustically transparent covering layer does not exceed 1000 Ns/m³. This value relates to the flow resistance of the entire first covering layer 52, i.e. in the embodiment shown in relation to the first lattice prepreg 58 together with the surface material 60.

To this effect the panel 140 of the second exemplary embodiment in FIGS. 4 and 5 comprises a second lattice prepreg 162 that is connected in a planar fashion to the core layer 150. Furthermore, on the rear of the lattice prepreg, i.e. in FIG. 5 on the left-hand side of the lattice prepreg 162, a water-impermeable foil 164 is provided that comprises a weight per unit area of at most 100 grams per square meter. However, in order to ensure acoustic transparency of the second covering layer 154, the foil 164 is not arranged so as to be taut on the lattice prepreg 162, instead it is only loosely held, preferably at the edges of the panel, because it is the sole function of the foil to prevent any infiltration of condensed water from the rear of the panel, i.e. from the region of the space between the cabin panel and the exterior skin. This embodiment of the second covering layer 154 ensures that the sound fraction with low frequencies can penetrate the second covering layer in order to be absorbed by the fuselage insulation situated behind the panel in the region of the exterior skin 22.

In a further embodiment, a cabin panel 240 is, for example, provided as a partition wall within the cabin 16. The acoustic requirements of a cabin partition wall are shown in FIG. 6. Incident noise 46 occurs on both sides of the panel 240. In order to reduce the sound level within the cabin 16, in the embodiment shown in FIGS. 6 and 7, too, acoustic absorption 48 takes place within the panel 240.

As is the case in the two embodiments, described above, of a panel according to the invention, the panel 240 comprises a core layer 250, a first covering layer 252 and a second covering layer 254, wherein the second covering layer 254 is arranged opposite the first covering layer 252. The first covering layer 252 comprises a first space-enclosing surface 256. The first covering layer 252 is designed in a manner so as to be analogous to the first covering layers 52 and 152 from FIGS. 3 and 5, i.e. it comprises a first lattice prepreg 258 on which a first cover 260 is arranged as a surface material, wherein in the present embodiment, for example, a woven fabric can be provided.

The second covering layer 254 also has multiple layers and comprises a second lattice prepreg 262. Furthermore, it is provided for the second covering layer 254 to comprise a second cover 264 that forms a second space-enclosing surface 266. The second cover 264 can, for example, be a woven fabric. In order to ensure that the sound 46 penetrates the first covering layer 252 and the second covering layer 254, both covering layers 252, 254 are designed so as to be acoustically transparent, and to this effect they comprise, for example, a flow resistance that in each case does not exceed 1000 Ns/m³.

The core layer 250 comprises a sound-absorbing open-pore core material so that, when the sound 46 enters the core layer, absorption 48 of the sound takes place.

The required flexural rigidity of the panel 240 is achieved in that the first covering layer 252 and the second covering layer 254 are connected in a planar fashion to the core layer 250, and for this purpose each of the two lattice prepregs 258, 262 is connected in a planar fashion to the core layer, i.e. along its lattice lines the lattice prepreg is connected in a planar fashion to the core layer 250, thus resulting in a bonding effect of the three layers.

Depending on the particular application of the panel 40, 140, 240 within the aircraft cabin, the front of the woven fabric can comprise a layer that provides a self-cleaning effect; for example such a layer can comprise titanium dioxide.

The described embodiments of the panels 40, 140, 240 relate to the structure in at least one region of the panel.

Preferably, the panels 40, 140, 240 comprise the described structure in the region of their surface and are different only at their edges, for example circumferentially. According to the invention, the panels can, for example at their edges, comprise different structures, for example in order to be more easily adaptable to complicated edge geometries or in order to be able to more easily meet the special requirements relating to the structural connection of the panels.

Particularly preferable are panels 40, 140, 240 in which the described structure is provided over the entire panel area, including the edges.

FIG. 8 shows a further view of a cross section of an aircraft fuselage. in addiction to the already described lateral cabin linings 24, 26 and the upper cabin lining 28, provided in the upper region, along the exterior wall 22 of the aircraft fuselage, also components of the already mentioned air conditioning or ventilation plant are shown. For example, in the upper region behind the cabin linings 28 there are air guides 70 for supplying supply air to the cabin, wherein the supplied air is provided by an air treatment unit (not shown in further detail). Blowing-in the supply air takes place by way of upper air outlet openings 71 which by way of branch lines 72 are connected to the air guides 70. Furthermore, for supplying supply air in close proximity to the passengers, lateral air outlet openings 73 are provided, which are also connected to the air guides 70.

Suction removal or leading away the cabin air takes place, among other things, in the lower region of the lateral cabin linings 24, 26. In that location the air is led away and as a rule at least some of it is again fed to the air treatment unit.

For suction removal, corresponding air guides (not shown in detail) are provided behind the cabin linings 24, 26. To make it possible for the air from the cabin to reach these air guides, a gap is provided between the cabin linings 24, 26 and the floor 20.

Apart from the function of allowing suction removal of the air supplied in the ceiling region, the gap can also be used to ensure air exchange between the cabin and the remaining air volume within the aircraft in the case of a sudden loss of pressure, and for this purpose it is also possible to use additional flaps that open only from a particular pressure differential onwards while otherwise being acoustically closed.

However, the air gap required for the air exchange of the air conditioning system is permanently open, which will be described in more detail with reference to FIGS. 9 and 10.

As shown in FIG. 9, an aircraft cabin panel 79, e.g. of the cabin lining 24, at its lower end in section view comprises a slight projection 80 so that an open gap 81 is found through which air exchange between the cabin region and the region behind the cabin lining 24 is possible. At the same time, however, the sound from the region behind the cabin lining 24, which sound is reflected by the fuselage, can enter the cabin region without hindrance, which is indicated by arrow 82.

In order to reduce this sound input, the cabin lining 24 according to the invention comprises a panel in which a second region 83 is formed that comprises the already mentioned sandwich construction, wherein the second region is arranged in an edge region of the panel.

In the second region 83a second covering layer 84 comprises a space-enclosing surface, and a first covering layer 85 forms a rear area of the cabin lining. The first and the second covering layers are connected in planar fashion to a core layer 86.

FIGS. 10 and 11 show a further exemplary embodiment of the panel according to the invention, in which an edge region, which in an installation situation is a lower edge region, comprises a multiple-shell construction and forms a hollow space 87, for guiding air or for conveying air, of an air conditioning or ventilation plant of an aircraft.

The hollow space 87 forms a free cross-sectional region or free flow cross-section, which is formed by walls, which cross-sectional region or flow cross-section, for guiding or conveying the flow-through of the air to be removed or supplied, comprises a duct-like through-opening in the edge region of the panel. The hollow space 87 is open in at least two regions; for this purpose the hollow space 87, which is diagrammatically shown in section view, comprises at least one first opening through which the air can enter the hollow space, and at least one second opening from which the air can issue from the hollow space.

As shown in the diagram, the first covering layer 85 of the second region 83 is arranged so as to face the hollow space 87.

The hollow space 87, which in FIG. 11 is shown in cross-sectional view, is, for example, longitudinally directed, with its longitudinal sides extending parallel to the edge region of the panel of the cabin lining 24. Furthermore, on a first longitudinal side 88, which points towards the edge region, and on a second longitudinal side 89, which is opposite the aforesaid, the hollow space is open at least in part. The two opening regions at the longitudinal sides make it possible for air to flow through the hollow space in transverse direction relative to its longitudinally-directed overall volume.

In order to form an offset sound path, the hollow space 87 comprises an offset in the direction of flow-through, indicated by an arrow 90.

According to a further embodiment (not shown in detail), the sound path is designed as a labyrinth.

In a further embodiment, the hollow space 87 is delimited by a hollow-space wall 91 that comprises the sandwich construction, wherein in each case the first covering layer 85 is arranged so as to face the hollow space 87.

For example, the hollow space 87 is delimited on one side by a first wall segment 91a that comprises the sandwich construction according to the invention with a core layer 86a, a first covering layer 85a and a second covering layer 84a. The first covering layer 85a and the second covering layer 84a are connected in planar fashion to the core layer 86a. Furthermore, a projection is provided as an offset 92 in the sound path which also comprises the sandwich construction according to the invention, i.e. a core layer 86b, a first covering layer 85b and a second covering layer 84b. In this arrangement, too, the first covering layer 85b and the second covering layer 84b are connected in planar fashion to the core layer 86b.

According to a further embodiment, a combination of the various embodiments of the above-described second region 83 comprising one or several of the various embodiments of the first region 55 in a panel is provided, which in FIG. 8 is indicated by the reference characters 55 and 83, but which is not shown in further detail.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

1. An aircraft cabin panel for sound reduction in an interior space, which aircraft cabin panel in at least one region comprises a sandwich construction with:
a core layer;
a first covering layer; and
a second covering layer;
wherein the core layer comprises a sound-absorbing open-pore core material;
wherein the first and the second covering layers are connected in a planar fashion to the core layer;
wherein the first covering layer is arranged in the direction of the sound waves to be absorbed, and the second covering layer is arranged opposite the first covering layer; and
wherein the first covering layer is designed so as to be acoustically transparent.

2. The aircraft cabin panel of claim 1,
in which for the purpose of sound absorption in the interior space a first region comprises the sandwich construction, wherein the first covering layer comprises a first space-enclosing surface.

3. The panel of claim 2, in which the second covering layer comprises a second space-enclosing surface.

4. The panel of claim 1, in which edge regions are provided, and wherein the core layer, which is connected in a planar fashion to the first and the second covering layers, which core layer comprises the sound-absorbing open-pore core material, extends between the edge regions.

5. The panel of claim 1, in which the core layer, which is connected in a planar fashion to the first and second covering layers and which comprises the sound-absorbing open-pore core material, extends across the entire panel.

6. The panel of claim 1, in which the first covering layer has multiple layers and has a first lattice prepreg and a first cover that forms the first surface; and wherein the first lattice prepreg is connected in a planar fashion to the core layer.

7. The panel of claim 1, in which the second covering layer has multiple layers and has a second lattice prepreg and a second cover that forms the second surface.

8. The panel of claim 6, in which the first cover has multiple layers.

9. The panel of claim 7, in which the second cover has multiple layers.

10. The panel of claim 8, in which a nonwoven formed fabric is provided between the cover and the lattice prepreg.

11. The panel of claim 1, in which the second covering layer is acoustically transparent.

12. The panel of claim 1, in which the second covering layer is designed so as to be acoustically insulating.

13. The panel of claim 1, in which in each case the flow resistance of the acoustically transparent covering layers does not exceed 1000 Ns/m³.

14. The panel of claim 11, in which the second covering layer has multiple layers and comprises a second lattice prepreg; and wherein the second lattice prepreg is connected in a planar fashion to the core layer.

15. The panel of claim 14, in which the second covering layer comprises a thin water-impermeable foil that has a weight per unit area of at most 100 g/m².

16. The panel of claim 1, in which for the purpose of reducing the sound input in the interior a second region is provided that comprises the sandwich construction; wherein in the second region the second covering layer comprises a space-enclosing surface, and the first covering layer forms a rear area of a cabin lining.

17. The panel of claim 16, in which the second region is arranged in an edge region of the panel.

18. The panel of claim 16, in which the edge region comprises a multiple-shell construction and forms a hollow space for guiding the air of an air conditioning or ventilation plant of an aircraft; wherein the first covering layer of the second region is arranged so as to face the hollow space.

19. The panel of claim 16, in which the hollow space is longitudinally directed, with its longitudinal sides extending parallel to the edge region;
wherein for removing air or for supplying air the hollow space is partly open on a first longitudinal side.

20. The panel of claim 16, in which in the direction of through-flow the hollow space comprises at least one offset and forms an offset sound path.

21. The panel of claim 16, in which the hollow space is delimited by a hollow-space wall that comprises the sandwich construction, wherein in each case the first covering layer is arranged so as to face the hollow space.

22. The panel of claim 16, in which the first covering layer of the second region is arranged on the opposite side of the covering layer of the first region.

23. An aircraft comprising a fuselage construction and a cabin that is arranged within the fuselage, which cabin, at least in some sections, is enclosed by an interior lining made from panels, in which aircraft at least some of the panels are designed as sound-absorbing panels of claim 1.
